(19) United States
(12) Patent Application Publication
(10) Pub. No.: US 2013/0186979 A1
(43) Pub. Date: Jul. 25, 2013

(54) Nozzle Head for Air Pump

(71) Applicant: Scott Wu, Taichung City (TW)

(72) Inventor: Scott Wu, Taichung City (TW)

(21) Appl. No.: 13/353,382

(22) Filed: Jan. 19, 2012

(51) Int. Cl. B05B 1/20

(52) U.S. Cl. 239/268

(57) ABSTRACT

A nozzle head, which can be used to pump air into a tire or a shock absorber, includes a housing, a sleeve, and an activating member. The housing is engagable with a pumping mechanism of an air pump. The sleeve is disposed in and rotatable with respect to the housing. The sleeve includes a channel and also includes a first end adapted for receiving an American valve and a second end adapted for receiving a French valve respectively. The activating member is disposed in the sleeve and movable to a first position in which the sleeve includes the first end in fluid communication with the channel and the second end not in fluid communication with the channel and a second position in which the sleeve includes the second end in fluid communication with the channel and the first end not in fluid communication with the channel.

### BACKGROUND OF THE INVENTION

1. Field of the Invention

The present invention relates to a nozzle head for an air pump.

2. Description of the Related Art

U.S. Pat. No. 5,921,269 and DE 102008057713 to the applicant each shows a nozzle head engagable with an air pumping mechanism, which can then be used to pump air into a tire or a shock absorber. Moreover, the nozzle head is compatible to an American valve and a French valve. In order to be convenient, each of these nozzle heads is a “two-head” design, with one head for an American valve and the other for a French valve. However, it is still desirable to invent a nozzle head that can engage with any valves in a secure and airtight manner.

The present invention is, therefore, intended to obviate or at least alleviate the problems encountered in the prior art.

### SUMMARY OF THE INVENTION

According to the present invention, a nozzle head for an air pump, which can be used to pump air into a tire or a shock absorber, includes a housing, a sleeve, and an activating member. The housing includes a first extension and a second extension extending transversely from the first extension. The first extension delimits a first chamber extended therethrough. The housing is engagable with a pumping mechanism of an air pump, which connects to the second extension. The sleeve is disposed in the first chamber and rotatable with respect to the housing and delimits a second chamber and a channel. The second chamber is extended from a first end to a second end of the sleeve, and the first end is adapted for receiving an American valve and the second end is adapted for receiving a French valve respectively, with the nozzle head and the American valve adapted to be airtightly engaged with each other in thread engagement, with the nozzle head and the French valve adapted to be airtightly engaged with each other in non-thread engagement. The channel is extended transversely from the second chamber and includes an opening on an outer periphery of the sleeve. The activating member is disposed in the second chamber and movable axially therein and defines a first section and a second section, with the first and second sections for abutting against different valves. The first section delimits a third chamber, which includes a valve stem and an air seal disposed therein. The valve stem is adapted for abutting against the American valve and the air seal adapted to be pressed by the American valve and achieve an airtight effect. The activating member is movable to a first position in which the sleeve includes the first end in fluid communication with the channel and the second end not in fluid communication with the channel and a second position in which the sleeve includes the second end in fluid communication with the channel and the first end not in fluid communication with the channel.

It is an object of the present invention to provide a nozzle head that can engage with different kinds of valves in a secure and airtight manner.

It is another object of the present invention to provide a nozzle head for an air pump, which can then be used to pump air into a tire or a shock absorber.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a nozzle head for an air pump in accordance with a first embodiment of the present invention.

FIG. 2 is an exploded perspective view of the nozzle head of FIG. 1.

FIG. 3 is a cross-sectional view of the nozzle head of FIG. 1.

FIG. 4A is a cross-sectional view showing the nozzle head of FIG. 1 operably moved to engage with an American valve of a tire.

FIG. 4B is an extended view of FIG. 4A and shows the operation that air flows into the American valve to inflate the tire.

FIG. 5A is a cross-sectional view showing the nozzle head of FIG. 1 engaged with a French valve of a tire.

FIG. 5B is an extended view of FIG. 4A and shows the operation that air flows into the French valve to inflate the tire.

FIG. 6 is a cross sectional view showing the nozzle head of FIG. 1 engaged with a valve of a shock absorber and the operation that air is pumped into the shock absorber.

FIG. 7 shows the nozzle head of FIG. 1 engagable with a pumping mechanism of a floor pump.

FIG. 8 shows the nozzle head of FIG. 1 engagable with a pumping mechanism of a mini pump.

FIG. 9 is a cross-sectional view of a nozzle head for an air pump in accordance with a second embodiment of the present invention.

### DETAILED DESCRIPTION OF THE PREFERRED EMBODIMENTS

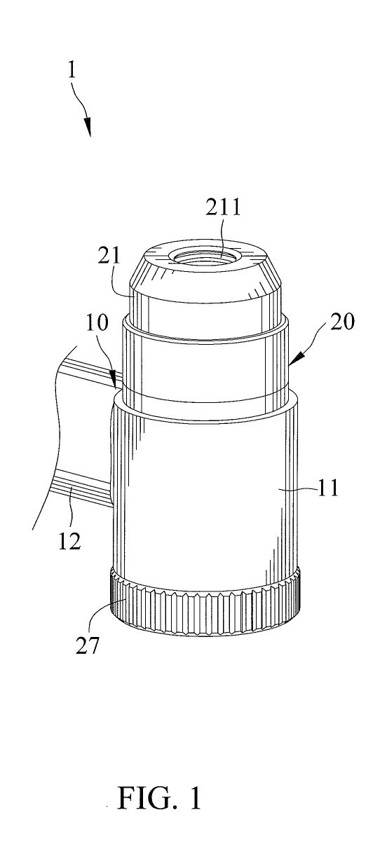

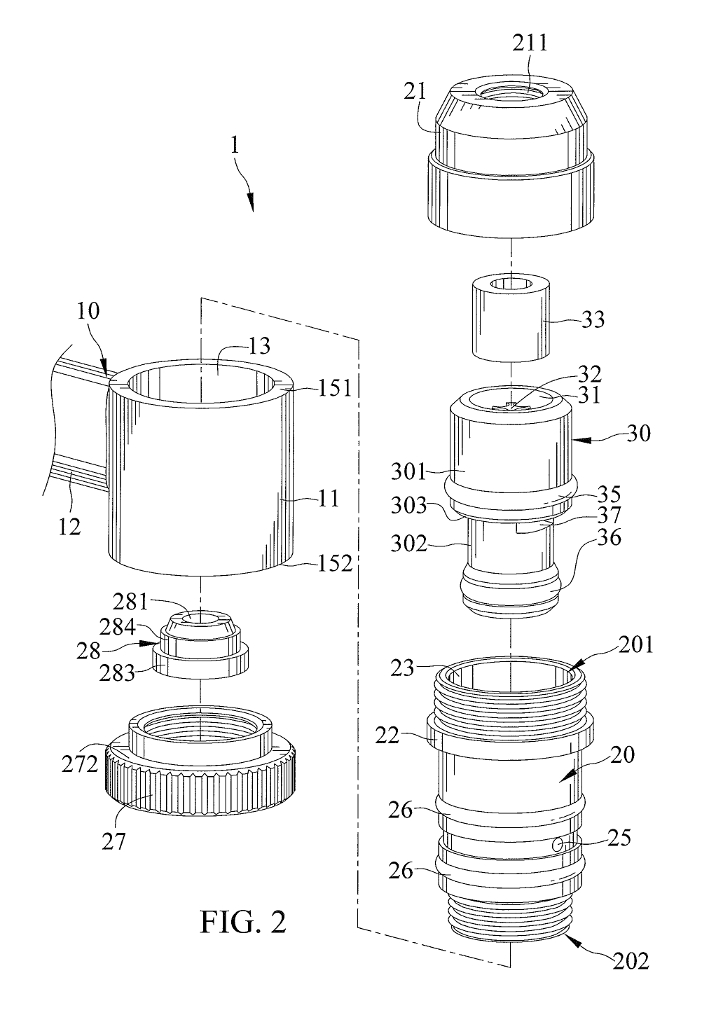

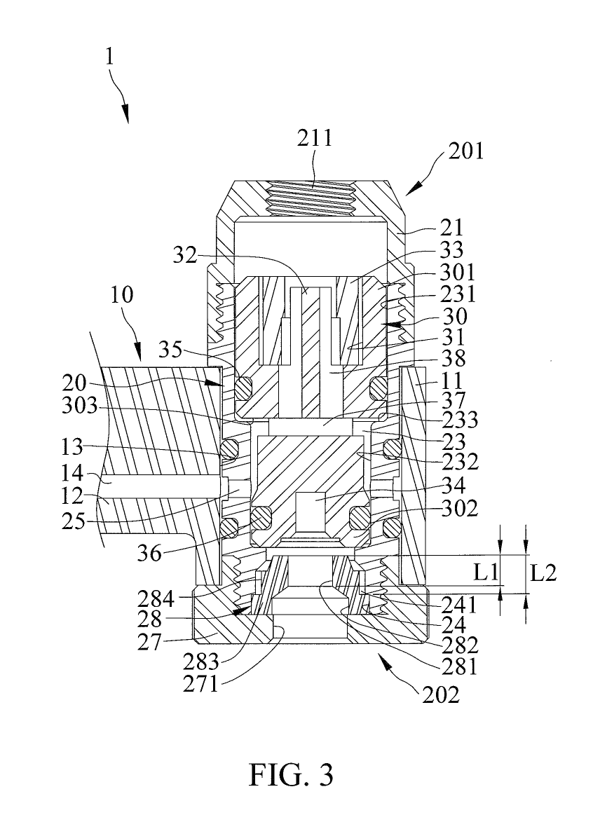

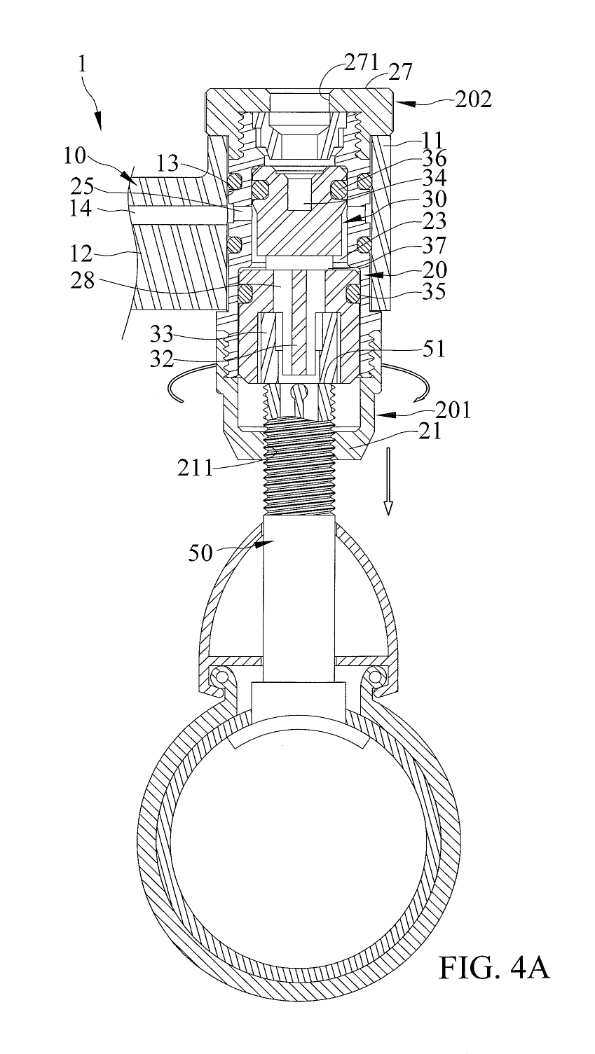

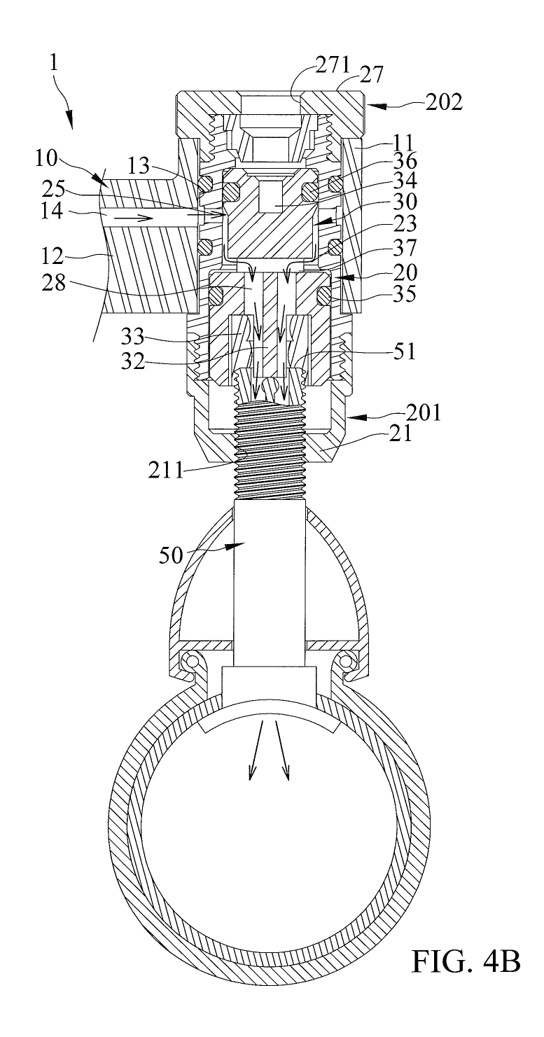

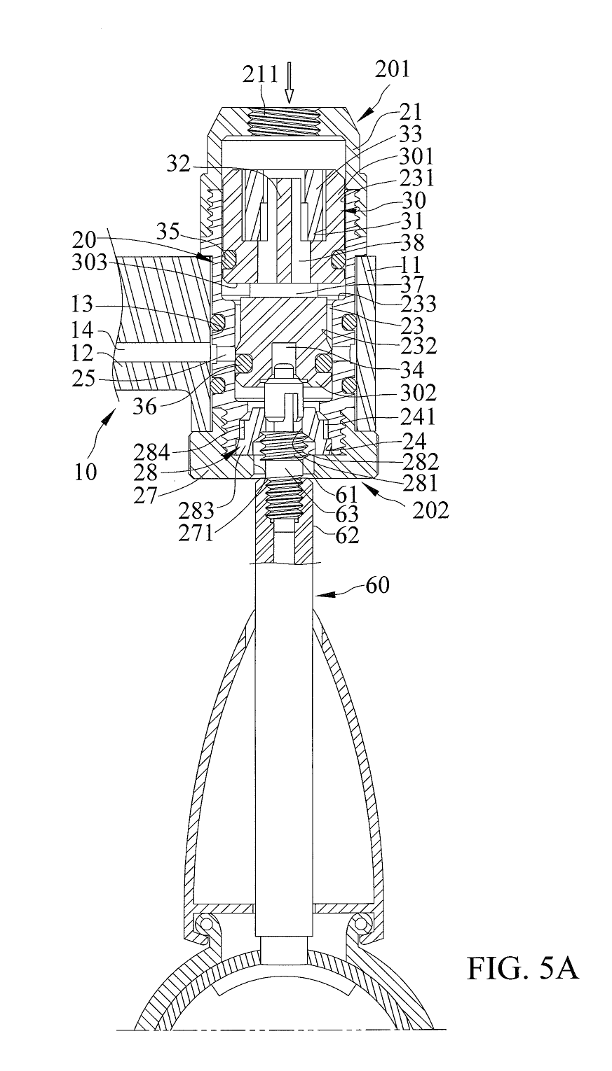

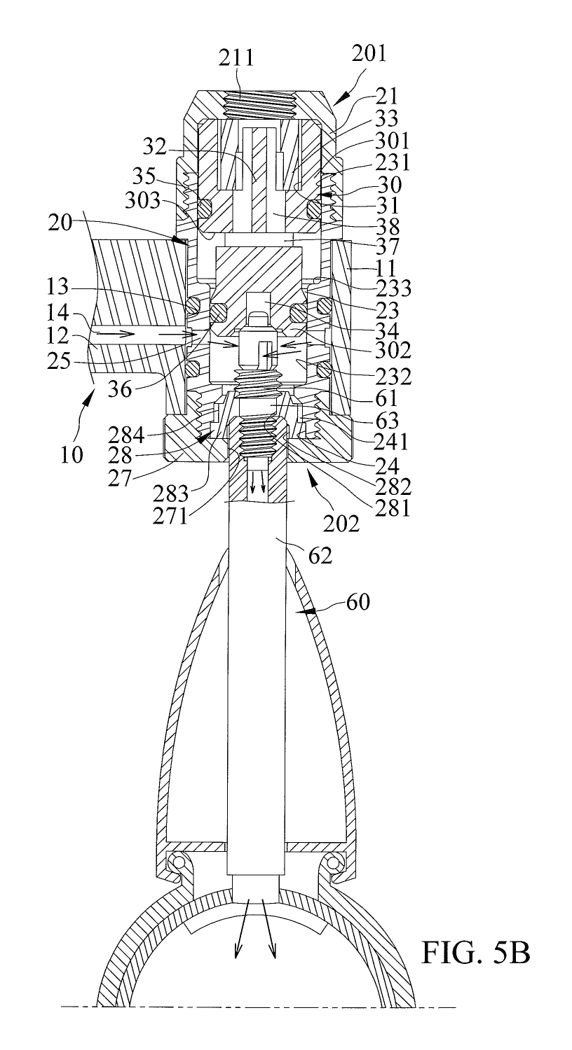

Referring to the FIGS. 1 through 8, a nozzle head 1 for an air pump in accordance with a first embodiment of the present invention includes a housing 10, a sleeve 20, and an activating member 30.

The housing 10 includes a first extension 11 and a second extension 12 extending transversely from the first extension 11. The first extension 11 delimits a first chamber 13 extended therethrough. The second extension 12 delimits a passage 14 in fluid communication with the first chamber 13. The housing 10 is engagable with a pumping mechanism of an air pump, which connects to the second extension 12. The housing 10 defines first and second distal ends defining first and second stopping surfaces 151 and 152.

The sleeve 20 is disposed in the first chamber 13 and rotatable with respect to the housing 10. The sleeve 20 includes an outer periphery including a flange 22 extended thereon and supported by the first stopping surface 151 and at least two first o-rings 26 fitted thereon to prevent air leaks. The sleeve 20 delimits a second chamber 23 and a channel 25. One of the at least two first o-rings 26 is disposed to the left side of the channel 25 and the other of the at least two second o-rings 26 is disposed to the right side of the channel 25 respectively. The second chamber 23 defines larger and smaller chamber sections 231 and 232. The larger chamber section 231 is larger in diametrical size than the smaller chamber section 232. Further, a stop wall 233 is extended from a periphery of the larger chamber section 231 to a periphery of the smaller chamber section 232. The second chamber 23 is extended from a first end 201 to a second end 202 of the sleeve 20, and the first end 201 is adapted for receiving an American valve 50 and the second end 202 is adapted for receiving a French valve 60 respectively, with the nozzle head 1 and the American valve 50 adapted to be airtightly engaged with each other in thread engagement, with the nozzle head 1 and the French valve 60 adapted to be airtightly engaged with each other in non-thread engagement. The second chamber 23 defines a receiving section 24 at the second end 202 of the sleeve 20, with the receiving section 24 receiving a seal ring 28, which is adapted for air-tightly surrounding and non-threadly engaging with the French valve 60, as well as allows the French valve 60 to be able to be abutted against the second section 302 of the activating member 30. The seal ring 28 delimits a throughhole 281 for receiving the French valve 60 and defines a fitting section 283 and a restraining section 284, with the fitting section 283 abutted against a wall delimiting the receiving section 24 and the restraining section 284 spaced from the wall and defining a gap 241, which allows air to be able to flow thereinto, thereby forcing the restraining section 284 to depress an outer periphery of the French valve 60 radially and enabling the French valve 60 to be air-tightly surrounded and securely held by the seal ring 28. The throughhole 281 has a diametrical size smaller than that measuring the outer periphery of the French valve 60. Further, section of the throughhole 281 delimited by the restraining section 284 defines a first hole section adapted for surrounding a neck 63 of the French valve 60, which separates smaller and larger outer peripheral sections 61 and 62 of the French valve 60. The smaller outer peripheral section 61 defines a thread section. Further, section of the throughhole 281 delimited by the fitting section 283 defines a space 282 having a diametrical size larger than a diametrical size of the first hole section and such that the French valve 60 engaged in the throughhole 281 includes the larger outer peripheral section 62 stopped in an area between the first hole section and the space 282 and prevented from being inserted in the first hole section. Moreover, the seal ring 28 includes the first hole section of the throughhole 281 extended in a first direction and having a first longitudinal length L1 greater than that measuring a longitudinal length of the neck 63. Moreover, the seal ring 28 includes the restraining section 284 having a second longitudinal length L2 in the first direction, which is greater than the first longitudinal length L1. The channel 25 is extended transversely from the second chamber 23 and includes an opening on the outer periphery of the sleeve 20. Further, first and second caps 21 and 27 are engaged with the first and second end 201 and 202 of the sleeve 20 respectively. The sleeve 20 and the second cap 27 can be made integrally as one piece. The first cap 21 delimits a first aperture 211 with a threaded periphery adapted for threadly receiving the American valve 50. The second cap 27 delimits a second aperture 271 adapted for an insertion of the French valve 60. The second cap 27 includes a protuberance 272 disposed outside the first chamber 13 and supported by the second stopping surface 152. The first and second apertures 211 and 271 are in fluid communication with the second chamber 23. Additionally, the second aperture 271 has a diametrical size larger than the larger outer peripheral section 62 of the French valve 60.

The activating member 30 is disposed in the second chamber 23 and movable axially therein and defines a first section 301 and a second section 302. The first and second sections 301 and 302 are used for abutting against different valves. The first section 301 delimits a third chamber 31, which includes a valve stem 32 and an air seal 33 disposed therein. The valve stem 32 is adapted for abutting against the American valve 50 and the air seal 33 adapted to be pressed by a distal end 51 of the American valve 50 and achieve an airtight effect. The activating member 30 is movable to a first position in which the sleeve 20 includes the first end 201 in fluid communication with the channel 25 and the second end 202 not in fluid communication with the channel 25 and a second position in which the sleeve 20 includes the second end 202 in fluid communication with the channel 25 and the first end 201 not in fluid communication with the channel 25. The activating member 30 includes the first section 301 received in the larger chamber section 231 and the second section 302 received in the smaller chamber section 232 respectively. The first section 301 is shorter in length than the larger chamber section 231 and larger in diametrical size than the second section 302. Moreover, the activating member 30 includes an outer periphery including a second and third o-rings 35 and 36 fitted thereon to prevent air leaks, a first conduit 37 extended therein and including an opening on the outer periphery, and a second conduit 38 in communication with the first conduit 37 and extending from the first conduit 37 to the third chamber 31. The third o-ring 36 is movable to the left and right sides of the channel 25. One of the second and third o-ring 35 and 36 is disposed to the left side of the conduit 37 and the other disposed to the right side of the conduit 37 respectively.

Further, a shoulder 303 is formed and extended from a periphery of the first section 301 to a periphery of the second section 302. The shoulder 303 is abutted against the stop wall 233 to stop the first section 301 from trespassing into the smaller chamber section 232.

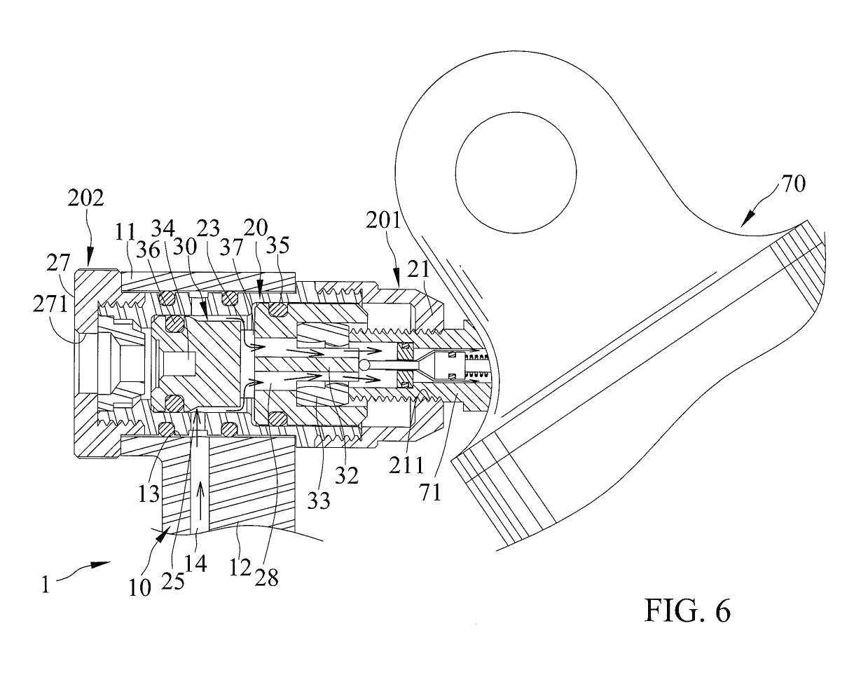

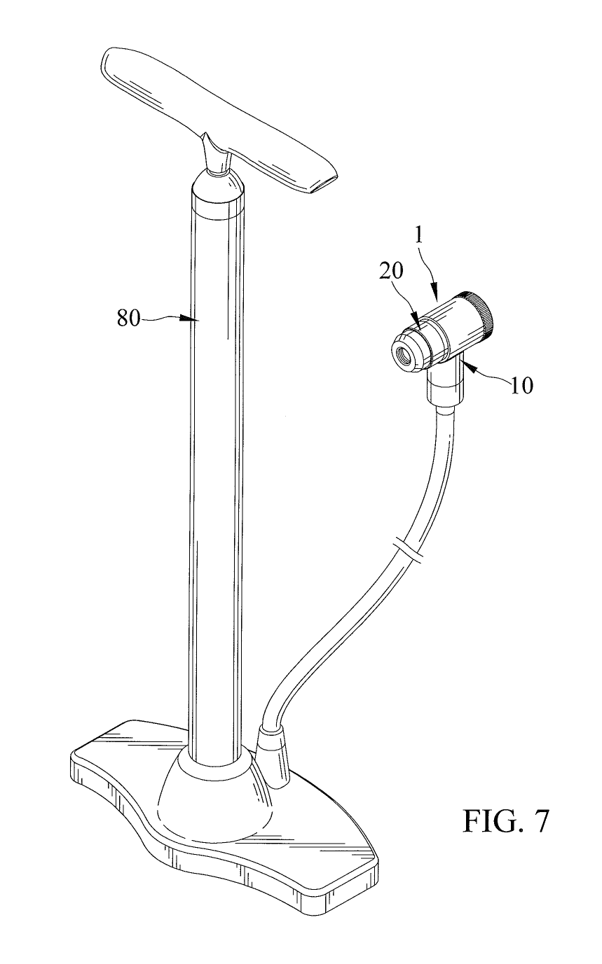

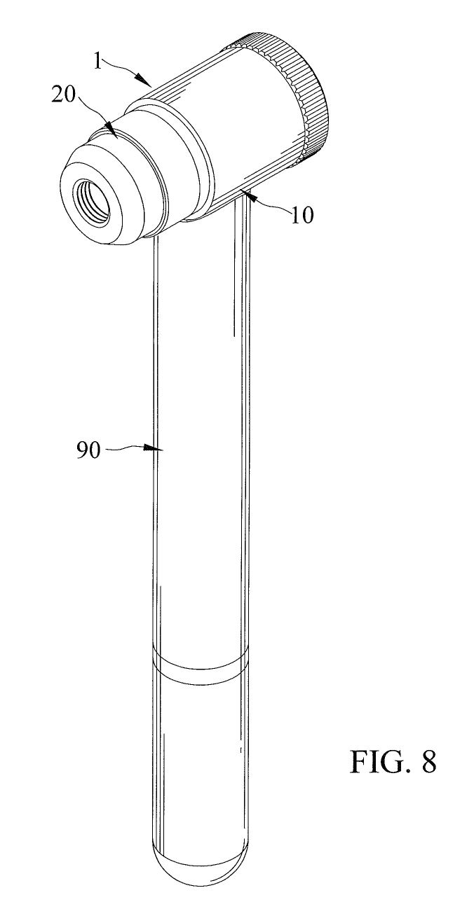

FIG. 6 shows the nozzle head is fluidly engagable with a valve 71 of the shock absorber 70. FIGS. 7 and 8 respectively show the nozzle head 1 is engagable with a pumping mechanism of a floor pump 80 and a frame pump 90.

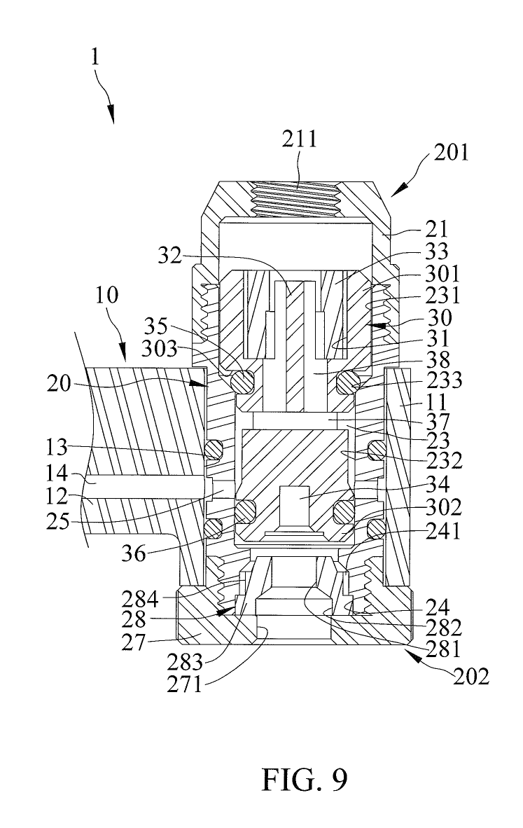

FIG. 9 is a nozzle head 1 in accordance with a second embodiment of the present invention. As shown in FIG. 9, the stop wall 233 can be a sloped surface and the second o-ring 35 is movable to selectively abut against the stop wall 233.

While the specific embodiments have been illustrated and described, numerous modifications come to mind without significantly departing from the spirit of invention, and the scope of invention is only limited by the scope of the accompanying claims.

What is claimed is:

1. A nozzle head for an air pump, which can be used to pump air into a tire or a shock absorber, comprising:
a housing including a first extension and a second extension extending transversely from the first extension, with the first extension delimiting a first chamber extended therethrough, with the housing engagable with a pumping mechanism of an air pump, which connects to the second extension;
a sleeve disposed in the first chamber and rotatable with respect to the housing and delimiting a second chamber and a channel, with the second chamber extended from a first end to a second end of the sleeve respectively, with the first end adapted for receiving an American valve and the second end adapted for receiving a French valve, with the nozzle head and the American valve adapted to be airtightly engaged with each other in thread engagement, with the nozzle head and the French valve adapted to be airtightly engaged with each other in non-thread engagement, with the channel extended transversely from the second chamber and including an opening on an outer periphery of the sleeve;
an activating member disposed in the second chamber and movable axially therein and defining a first section and a second section, with the first and second sections for abutting against different valves, with the first section delimiting a third chamber, which includes a valve stem and an air seal disposed therein, with the valve stem adapted for abutting against the American valve and the air seal adapted to be pressed by the American valve and achieve an airtight effect, with the activating member movable to a first position in which the sleeve includes the first end in fluid communication with the channel and the second end not in fluid communication with the channel and a second position in which the sleeve includes the second end in fluid communication with the channel and the first end not in fluid communication with the channel.

2. The nozzle head as claimed in claim 1, wherein the second chamber defines a receiving section at the second end of the sleeve, with the receiving section receiving a seal ring, which is adapted for air-tightly surrounding and non-threadly engaging with the French valve, as well as allows the French valve to be able to be abutted against the second section of the activating member, wherein the seal ring delimits a throughhole for receiving the French valve and defines a fitting section and a restraining section, with the throughhole having a diametrical size smaller than that measuring an outer periphery of the French valve, with the fitting section abutted against a wall delimiting the receiving section and the restraining section spaced from the wall and defining a gap, with air being able to flow into the gap, thereby forcing the restraining section to depress the outer periphery of the French valve radially and enabling the French valve to be air-tightly surrounded and securely held by the seal ring.

3. The nozzle head as claimed in claim 2, wherein section of the through hole of the seal ring delimited by the restraining section defines a first hole section adapted for surrounding a neck of the French valve, which separates smaller and larger outer peripheral sections of the French valve, with the smaller outer peripheral section defining a thread section, with the first hole section extending in a first direction and having a first longitudinal length greater than that measuring a longitudinal length of the neck.

4. The nozzle head as claimed in claim 3, wherein the restraining section of the seal ring has a second longitudinal length in the first direction, with the second longitudinal length greater than the first longitudinal length.

5. The nozzle head as claimed in claim 3, wherein section of the through hole of the seal ring delimited by the fitting section defines a space, with the space having a diametrical size larger than a diametrical size of the first hole section of the through hole and such that the French valve engaged in the through hole includes the larger outer peripheral section stopped in an area between the first hole section and the space and prevented from being inserted in the first hole section.

6. The nozzle head as claimed in claim 2 further comparing first and second caps engaged with the first and second end of the sleeve respectively, with the first cap delimiting a first aperture with a threaded periphery adapted for threadly receiving the American valve, with the second cap delimiting a second aperture adapted for an insertion of the French valve, with the first and second apertures in fluid communication with the second chamber.

7. The nozzle head as claimed in claim 6, wherein the housing defines first and second distal ends defining first and second stopping surfaces, wherein the sleeve includes the outer periphery including a flange extended thereon, with the flange supported by the first stopping surface, wherein the second cap includes a protuberance disposed outside the first chamber and supported by the second stopping surface.

8. The nozzle head as claimed in claim 1, wherein the second chamber defines larger and smaller chamber sections, with the larger chamber section larger in diametrical size than the smaller chamber section, with a stop wall extending from a periphery of the larger chamber section to a periphery of the smaller chamber section, wherein the activating member includes the first section received in the larger chamber section and the second section received in the smaller chamber section respectively, with the first section shorter in length than the larger chamber section, with the first section larger in diametrical size than the second section, with a shoulder formed and extending from a periphery of the first section to a periphery of the second section, with the shoulder abutted against the stop wall to stop the first section from trespassing into the smaller chamber section.

9. The nozzle head as claimed in claim 8, wherein the sleeve includes the outer periphery including at least two first o-rings fitted thereon to prevent air leaks, with one of the at least two first o-rings disposed to the left side of the channel and the other of the at least two second o-rings disposed to the right side of the channel respectively, wherein the activating member includes an outer periphery including a second and third o-rings fitted thereon to prevent air leaks, a first conduit extended therein and including an opening on the outer periphery, and a second conduit in communication with the first conduit and extending from the first conduit to the third chamber, with the third o-ring movable to the left and right sides of the channel, with one of the second and third o-ring disposed to the left side of the conduit and the other disposed to the right side of the conduit respectively.

10. The nozzle head as claimed in claim 9, wherein the stop wall defines a sloped surface, wherein the second o-ring is movable to selectively abut against the stop wall.
